(19) United States
(12) Patent Application Publication
(10) Pub. No.: US 2012/0064912 A1
(43) Pub. Date: Mar. 15, 2012

(54) APPARATUS AND METHOD FOR GENERATING ACCESS POINT LIST IN MOBILE COMMUNICATION TERMINAL

(75) Inventor: Min-Taek OH, Gyeonggi-do (KR)

(73) Assignee: Samsung Electronics Co., LTD., Gyeonggi-Do (KR)

(21) Appl. No.: 13/228,858

(22) Filed: Sep. 9, 2011

(30) Foreign Application Priority Data
Sep. 15, 2010 (KR) 10-2010-0090324

(51) Int. Cl. H04W 24/00

(52) U.S. Cl. 455/456.1

(57) ABSTRACT

An apparatus and method for generating an Access Point (AP) list in a mobile communication terminal. The method preferably includes acquiring current position information of the mobile communication terminal, performing AP scan and determining if a beacon signal is received, when at least one beacon signal is received, acquiring corresponding AP information from the received beacon signal, and mapping the AP information with the current position information and storing the mapping result. The apparatus preferably includes a position information acquisition unit that acquires current position information of the mobile communication terminal. A communication module performs AP scan and receives a beacon signal. A controller receives at least one beacon signal, acquires corresponding AP information from the received beacon signal, and maps the AP information with the current position information.

### CLAIM OF PRIORITY

This application claims the benefit of priority under 35 U.S.C. §119(a) from a Korean Patent Application filed in the Korean Intellectual Property Office on Sep. 15, 2010 and assigned Serial No. 10-2010-0090324, the contents of which are herein incorporated by reference in its entirety.

### BACKGROUND OF THE INVENTION

1. Field of the Invention

The present invention relates to an apparatus and method for generating an Access Point (AP) list in a mobile communication terminal. More particularly, the present invention relates to an apparatus and method for generating an AP list based on position information of a mobile communication terminal.

2. Description of the Related Art

With the sudden growth of the Internet and the development of a wireless communication technology, attention to the wireless Internet is increasing day-by-day. Accordingly, in recent years, a mobile communication terminal now provides many functions that include a wireless Internet service using a Wireless Local Area Network (WLAN).

The conventional WLAN is composed of a mobile communication terminal (e.g., a notebook computer, a Personal Digital Assistant (PDA), and a portable phone) equipped with a wireless Network Interface Card (NIC), and an Access Point (AP) taking charge of a gateway role between each mobile communication terminal and an Internet Protocol (IP) network. By this construction, the mobile communication terminal accesses the AP and provides a wireless Internet service to a user of the mobile communication terminal.

The AP typically supports an area of about 20 to 150 meters and the AP are restricted in quantity, so a geographical area supporting the WLAN is restricted too. Accordingly, in the conventional art, when a mobile communication terminal attempts to use the WLAN, a user of the mobile communication terminal should remember an AP installation position in order to move within a corresponding area and attempt accessing a particular AP of the corresponding area or, when the user cannot remember the AP installation position, he/she should attempt to access a neighboring AP every time a position of the mobile communication terminal is changed. However, such a method is very inefficient in that whenever the position of the mobile communication terminal is changed, the user has to remember each particular AP position or must attempt to access the AP as above until successful. The conventional art provides a scheme of storing AP information and providing the AP information to a user in the mobile communication terminal.

More particularly, the conventional art provides a scheme in which the mobile communication terminal scans an AP, accesses the scanned AP, maps information of the accessed AP with current position information of the mobile communication terminal, stores the mapping result, and provides the AP information to a user according to a user's request. However, this conventional scheme does not and cannot provide information on an AP that the mobile communication terminal does not have ever previously accessed, because storing information on an AP is only with regard to those AP that the mobile communication terminal has previously accessed and provided the AP information to the user. Accordingly, the AP conventional information provision scheme continues to suffer from a disadvantage in that in order to access an AP that the mobile communication terminal have never previously accessed, the user needs to remember a position of the AP or the mobile communication terminal needs to attempt access to the AP in accordance with each position change.

The conventional art provides a scheme in which a service provider registers position information of an AP himself/herself, there is a limitation in providing AP information of all areas. Accordingly, despite the fact that an AP exists in an area where a user is positioned, information of the AP may not be provided.

### SUMMARY OF THE INVENTION

An exemplary aspect of the present invention is to substantially solve at least some the above problems and/or disadvantages and to provide at least some of the advantages below. Accordingly, one aspect of the present invention is to provide an apparatus and method for generating an Access Point (AP) list based on position information in a mobile communication terminal.

Another exemplary aspect of the present invention is to provide an apparatus and method for generating an AP list through AP scan instead of performing an AP access procedure in a mobile communication terminal.

A further exemplary aspect of the present invention is to provide an apparatus and method for providing an accessible AP list based on position information in a mobile communication terminal.

Yet another exemplary aspect of the present invention is to provide an apparatus and method for transmitting, to a specific server, an AP list generated based on position information in a mobile communication terminal to share the AP list with other mobile communication terminals.

The above exemplary aspects are achieved by providing an apparatus and method for generating an AP list in a mobile communication terminal.

According to one exemplary aspect of the present invention, a method for generating an Access Point (AP) list in a mobile communication terminal is provided. The method preferably includes acquiring current position information of the mobile communication terminal, performing AP scan and determining if a beacon signal is received, when at least one beacon signal is received, acquiring corresponding AP information from the received beacon signal, and mapping the AP information with the current position information and storing the mapping result.

According to still another exemplary aspect of the present invention, an apparatus for generating an AP list in a mobile communication terminal is provided. The apparatus preferably includes a position information acquisition unit, a communication module, a controller, and a storage unit. The position information acquisition unit acquires current position information of the mobile communication terminal. The communication module performs AP scan and receives a beacon signal. When at least one beacon signal is received, the controller acquires corresponding AP information from the received beacon signal, and maps the AP information with the current position information. The storage unit stores the mapped current position information and AP information.

### BRIEF DESCRIPTION OF THE DRAWINGS

The above and other exemplary objects, features and advantages of the present invention will become more apparent to a person of ordinary skill in the art from the following detailed description when taken in conjunction with the accompanying drawings in which:

FIG. 1 is a block diagram illustrating an exemplary construction of a mobile communication terminal according to the present invention; and

FIG. 2 is a flowchart illustrating a procedure of generating an Access Point (AP) list in a mobile communication terminal according to an exemplary embodiment of the present invention.

### DETAILED DESCRIPTION

Preferred exemplary embodiments of the present invention will now be described herein below with reference to the accompanying drawings. In the following description, well-known functions or constructions may not be described when they would obscure appreciation of the subject matter of the invention by a person of ordinary skill in the art with such well-known functions or constructions.

Exemplary embodiments of the present invention provide an apparatus and method for generating an Access Point (AP) list based on position information in a mobile communication terminal.

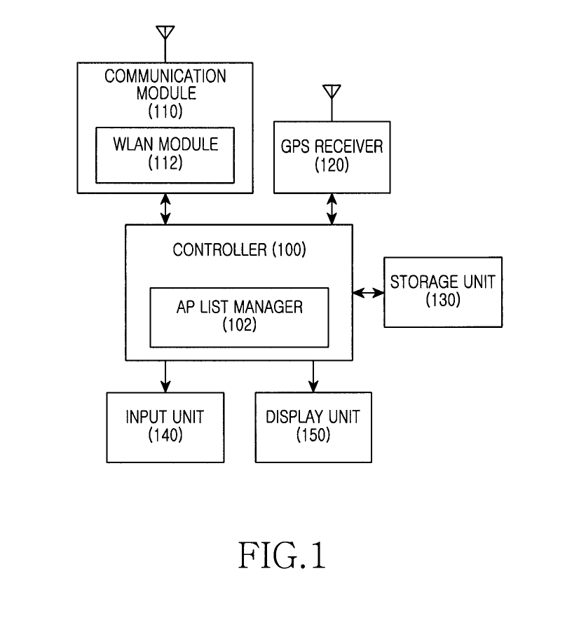

FIG. 1 illustrates exemplary construction of a mobile communication terminal according to the present invention.

Referring now to FIG. 1, the mobile communication terminal preferably includes a controller 100, a communication module 110, a Global Positioning System (GPS) receiver 120, a storage unit 130, an input unit 140, and a display unit 150. An artisan understands and appreciates that at least some of the aforementioned items can be integrated.

The controller 100, which typically includes a microprocessor controls and processes a general operation of the mobile communication terminal. According to the present invention, by including an AP list manager 102, the controller 100 controls and processes a function for, according to a preset condition, acquiring information of an AP corresponding to position information of the mobile communication terminal to generate an AP list.

Whenever a position of the mobile communication terminal changes more than a threshold range from the AP or after a preset period of time, preferably under the direction of the controller, the AP list manager 102 performs an AP scan, maps information of a searched AP to current position information of the mobile communication terminal, and generates and stores an AP list for the current position information. In other words, whenever a preset condition is met, the AP list manager 102 acquires the current position information of the mobile communication terminal, performs an AP scan, acquires from a beacon signal received by the mobile communication terminal, AP information (e.g., a Service IDentifier (SID), a signal strength, a channel, a Media Access Control (MAC) address and the like) corresponding to the beacon signal, maps the AP information with the current position information to generate an AP list, and stores the AP list in the storage unit 130.

Further, the AP list manager 102 preferably controls and processes a function for, when there is an AP list provision request from a user, acquiring current position information of the mobile communication terminal, searching an AP list corresponding to the current position information among the AP lists stored in the storage unit 130, and displaying the searched AP list on the display unit 150. At this time, when there is no AP list consistent with the current position information, the AP list manager 102 may search a neighboring AP list corresponding to the closest geographical position to the current position information and display the neighboring AP list on the display unit 150. Further, the AP list manager 102 may only display the neighboring AP list, but may also compare position information of the neighboring AP list with the current position information and display direction and distance information by which the mobile communication terminal will have to move for the sake of access to an AP included in the neighboring AP list. For instance, if the mobile communication terminal moves 50 meters (m) from a current position in an easterly direction, the AP list manager 102 may display that an accessible AP exists.

Further, when the mobile communication terminal displays an AP list on the display unit 150 in response to the AP list provision request of the user, the AP list manager 102 may indicate if each AP included in the AP list is of an open type or a closed type. Here, the AP list manager 102 may determine if the AP is of an open type or a closed type, through a Service Set IDentifier (SSID) of an AP acquired from the beacon signal. For example, in a case of a wired/wireless an Internet Protocol (IP) sharing device now sold on the market, the AP list manager 102 may determine if the IP sharing device is an IP sharing device accessible without user authentication, through the name (e.g., ‘ANYGATE’, ‘IPTIME’, ‘BELKIN’, or ‘DLINK’) predefined for the wired/wireless IP sharing device.

Further, the AP list manager 102 controls and processes a function for, in response to a user request, transmitting an AP list stored in the storage unit 130 to a specific server. Additionally, the AP list manager 102 controls and processes a function for, in response to the user request, receiving an AP list registered by another user from the specific server and storing the AP list.

The communication module 110 preferably performs a function of transmitting/receiving and processing a signal in a preset communication scheme according to the control of the controller 100. Particularly, by including a Wireless Local Area Network (WLAN) module 112, the communication module 110 transmits/receives and processes a signal for an AP.

Under the control of the controller 100, the GPS receiver 120 acquires a position coordinate that indicates current position information of the mobile communication terminal from a GPS satellite, and provides the acquired position coordinate to the controller 100.

With continued reference to FIG. 1, the storage unit 130 stores various programs and data necessary for a general operation of the mobile communication terminal. Particularly, the storage unit 130 receives an AP list from the AP list manager 102 and stores the AP list. The AP list includes information of at least one AP, and position information of the mobile communication terminal corresponding to the information of the AP. For one particular non-limiting example, the AP list may be configured as follows:

1. Position information (latitude—xx, xx, longitude—xx, xx)->AP list (‘ABC’, ‘DDC’, ‘RDD’), detailed information per AP (‘ABC’—signal strength/channel/MAC address, ‘DDC’—signal strength/channel/MAC address, ‘RDD’—signal strength/channel/MAC address);

2. Position information (latitude—xx, xx, longitude—xx, xx)->AP list (‘RDD’, ‘FEC’, ‘RDD’), detailed information per AP (‘RDD’—signal strength/channel/MAC address, ‘FEC’—signal strength/channel/MAC address, ‘RDD’—signal strength/channel/MAC address).

A person of ordinary skill in the art should understand and appreciate that the detailed information per AP according to the present invention may be changed according to designer's configuration or may be changed according to AP information included in a beacon signal.

With continued reference to FIG. 1, the input unit 140 preferably includes at least one of a keypad and a touch sensor, and provides a key input by a user or a position coordinate touched by the user, to the controller 100.

The display unit 150 preferably displays status information generated during an operation of the mobile communication terminal and various numerals, characters, and videos. More particularly, according to the control of the controller 100, the display unit 150 preferably displays an accessible AP list. Further, according to the control of the controller 100, the display unit 150 may display information by which the mobile communication terminal will have to move for AP access.

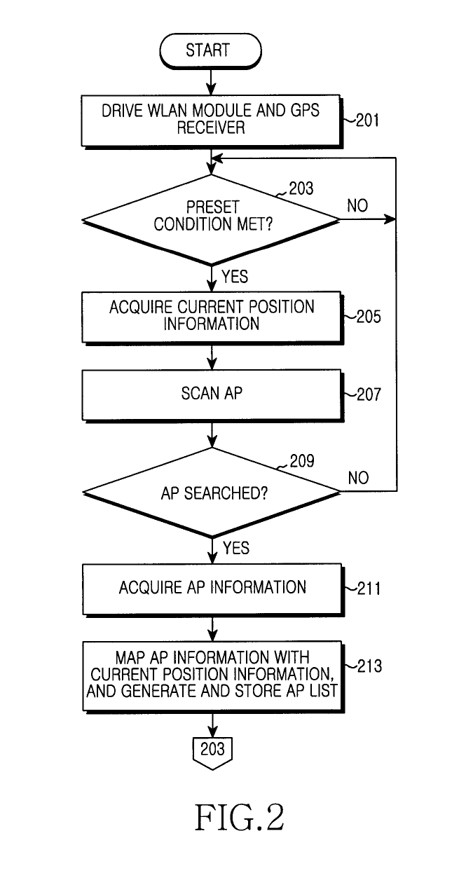

FIG. 2 illustrates an exemplary procedure of generating an AP list in a mobile communication terminal according to an exemplary embodiment of the present invention.

Referring now to FIG. 2, in step 201, the mobile communication terminal drives a WLAN module and a GPS receiver and then, the method proceeds to step 203 and determines if a preset condition for AP list generation is met. For example, the mobile communication terminal determines whether it is a time period preset for the AP list generation, or position information of the mobile communication terminal changes more than a threshold range of a current AP.

When the preset condition is met, the mobile communication terminal method proceeds to step 205 and acquires current position information of the mobile communication terminal.

In step 207, the mobile communication terminal performs a scan procedure for an AP. Here, the mobile communication terminal may perform an AP scan procedure for all frequency bands, or may perform an AP scan procedure only for a preset frequency band or a select group of frequency bands.

With continued reference to FIG. 2, at step 209 the mobile communication terminal determines if an AP is searched through the AP scan. That is, the mobile communication terminal may determine if an AP is searched, through the reception or non-reception of a beacon signal for the AP. When the AP is not searched, the mobile communication terminal determines that there is not an AP corresponding to a current position of the mobile communication terminal, and returns to step 203 and again performs the subsequent steps S203 through S209.

However, when at S209 the AP is searched, then at step 211 the mobile communication terminal acquires corresponding AP information from a beacon signal received by the mobile communication terminal. Here, the AP information acquired by the mobile communication terminal may include an SID, a signal strength, a channel, and a MAC address. According to the presently claimed invention, the AP information acquired by the mobile communication terminal may be changed according to designer's configuration, or may be changed according to AP information included in the beacon signal.

Next, at step 213, the mobile communication terminal maps the AP information with the acquired current position information to generate an AP list, and stores the generated AP list.

Next, at step 203 the mobile communication terminal again performs the subsequent steps.

As described above, exemplary embodiments of the present invention generate an AP list by position and store the AP list in a mobile communication terminal, thereby, if there is an AP list request from a user, acquiring current position information of the mobile communication terminal corresponding to a time point of receiving the AP list request from the user, searching an AP list corresponding to the acquired current position information among previously stored AP lists, and displaying the searched AP list on a screen.

According to an exemplary aspect of the present invention, when there is no AP list corresponding to the current position information of the mobile communication terminal, the mobile communication terminal may search a neighboring AP list corresponding to the closest position to the current position information and display the searched AP list on the screen. Here, the mobile communication terminal may just display the neighboring AP list, or may also compare the position information of the neighboring AP list with the current position information and display information by which the mobile communication terminal will have to move in order to have access to an AP included in the neighboring AP list. For example, if moving 50 meters from a current position in an easterly direction, the mobile communication terminal may display that an accessible AP exists and preferably provide the direction.

Further, the mobile communication terminal according to the present invention may apply a predetermined threshold range when searching an AP list neighboring on current position information of the mobile communication terminal. In other words, when position information of an AP list corresponding to the closest position to current position information of the mobile communication terminal among previously stored AP lists does not belong to a threshold range based on the current position information of the mobile communication terminal, the mobile communication terminal may determine that there is no AP accessible in the current position information, and inform a user of this determination. For example, when an AP list of a position distant several meters away from a current position of a mobile communication terminal is an AP list corresponding to the closest position to the current position of the mobile communication terminal, the mobile communication terminal may determine that there is an AP accessible in the current position, and provide this to the user and, in contrast, when an AP list of a position distant dozens of kilo meters away from a current position of the mobile communication terminal is an AP list corresponding to the closest position to the current position of the mobile communication terminal, the mobile communication terminal may determine that there is no AP accessible by the mobile communication terminal in the current position. Here, the threshold range for determining a neighboring AP list in the mobile communication terminal may be set and changed according to a movement speed of the mobile communication terminal. In other words, when a user of the mobile communication terminal is in movement at low speed, the threshold range may be set to be more narrow and, when the user is in movement at high speed, the threshold range may be set to be more wide.

Further, when a plurality of AP lists belongs within the threshold range based on the current position information of the mobile communication terminal, the mobile communication terminal may provide the plurality of AP lists to a user.

Further, in response to a user request, the mobile communication terminal may transmit an AP list stored by position in the mobile communication terminal to a specific server, and may receive an AP list corresponding to a current position or specific position, from the specific server.

As described above, exemplary embodiments of the present invention through mapping AP information searched through AP scan to current position information of a mobile communication terminal and generating and storing an AP list in the mobile communication terminal, are capable of acquiring the AP information within a short time, providing a user with information on an AP that has not been previously accessed by the particular mobile communication terminal, and easily acquiring the AP information even during movement. Further, the exemplary embodiments of the present invention provide a user with an AP list accessible in a current position and/or provide the user with the direction and distance information by which the user will have to move the mobile communication terminal for AP access, in order to allow the mobile communication terminal to easily access an AP.

The above-described methods according to the present invention can be implemented in hardware, firmware or as software or computer code that can be stored in a recording medium such as a CD ROM, an RAM, a floppy disk, a hard disk, or a magneto-optical disk or downloaded over a network and stored on a non-transitory machine readable medium, so that the methods described herein can be rendered in such software using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain preferred exemplary embodiments thereof, it will be understood by those skilled in the art that various changes in form and details may be made therein without departing from the spirit and scope of the invention as defined by the appended claims.

What is claimed is:

1. A method for generating an Access Point (AP) list in a mobile communication terminal, the method comprising:
acquiring by a Global Positioning System (GPS) receiver a current position information of the mobile communication terminal;
performing by a communication module an AP scan and determining if a beacon signal is received by a communication module;
when at least one beacon signal is received by a communication module, acquiring by a controller corresponding AP information from the received beacon signal; and
mapping the AP information with the current position information, and storing the mapping result in a storage unit.

2. The method of claim 1, wherein the corresponding AP information comprises at least one of a Service IDentifier (SID), a signal strength, a channel, and a Media Access Control (MAC) address.

3. The method of claim 1, further comprising:
determining by the controller whether a preset time period has elapsed or a position of the mobile communication terminal changes by more than a threshold range; and
whenever the preset time period has occurred or the position of the mobile communication terminal changes by more than the threshold range, the GPS receiver acquiring the current position information, and the controller controlling the communication module to perform a new AP scan.

4. The method of claim 1, further comprising:
when there is an AP list request received, the GPS receiver acquiring the current position information of the mobile communication terminal;
searching by the controller for at least one piece of AP information corresponding to the current position information, among the stored AP information; and
displaying on a display unit the searched for at least one AP information.

5. The method of claim 4, further comprising:
when there is no AP information corresponding to the current position information among the stored AP information, searching for at least one piece of neighboring AP information corresponding to position information being within a threshold range based on the current position information; and
displaying on a display unit the searched neighboring AP information.

6. The method of claim 5, further comprising displaying by the display unit a movement distance and a direction information for positioning the mobile communication terminal to permit access of a neighboring AP on a basis of the current position of the mobile communication terminal.

7. The method of claim 1, further comprising transmitting by the communication module the mapped and stored current position information and AP information to a specific server.

8. The method of claim 4, wherein the AP List includes information regarding an AP that has not been previously accessed by the mobile communication terminal.

9. The method of claim 4, wherein the AP List request comprises AP information regarding a neighboring AP that is beyond a threshold range to communicate with the mobile communication terminal.

10. An apparatus for generating an Access Point (AP) list in a mobile communication terminal, the apparatus comprising:
a position information acquisition unit that acquires a current position information of the mobile communication terminal;
a communication module that performs an AP scan and receives a beacon signal;
a controller that receives at least one beacon signal, acquires corresponding AP information from the received beacon signal, and maps the AP information with the current position information; and
a storage unit that stores the mapped current position information and AP information.

11. The apparatus of claim 9, wherein the AP information comprises at least one of a Service IDentifier (SID), a signal strength, a channel, and a Media Access Control (MAC) address.

12. The apparatus of claim 9, wherein the controller determines whether a preset time period has elapsed or a position of the mobile communication terminal changes more than a threshold range.

13. The apparatus of claim 12, wherein when the preset time period has elapsed, the controller acquires the current position information, and controls performance of the AP scan.

14. The apparatus of claim 12, wherein when the position of the mobile communication terminal changes more than the threshold range, the controller acquires the current position information, and controls performance of the AP scan

15. The apparatus of claim 10, wherein, when there is an AP list request received, the controller receives the current position information of the mobile communication terminal from the position information acquisition unit, and searches for at least one piece of AP information corresponding to the current position information from among the stored AP information, and
wherein the apparatus the display unit displays a result of the searched for at least one AP information.

16. The apparatus of claim 15, wherein, when there is no AP information corresponding to the current position information of the mobile communication terminal from among the stored AP information, the controller searches for at least one piece of neighboring AP information corresponding to position information being within a threshold range of the mobile communication terminal based on the current position information, and
wherein the display unit displays the searched neighboring AP information.

17. The apparatus of claim 16, wherein the controller determines a movement distance and a direction information to position the mobile communication terminal to access a neighboring AP on a basis of a current position of the mobile communication terminal, and
wherein the display unit displays the determined movement distance and direction information.

18. The apparatus of claim 10, wherein the communication module transmits the mapped and stored current position information and AP information, to a specific server.
